(19) United States
(12) Patent Application Publication
(10) Pub. No.: US 2011/0316197 A1
(43) Pub. Date: Dec. 29, 2011

(54) INJECTION MOLDING SYSTEM AND METHOD

(75) Inventors: HAI-PING WANG, Shenzhen City (CN); XU LI, Shenzhen City (CN)

(73) Assignees: HON HAI PRECISION INDUSTRY CO., LTD., Tu-Cheng (TW); HONG FU JIN PRECISION INDUSTRY(Shenzhen) CO., LTD., Shenzhen City (CN)

(21) Appl. No.: 12/964,247

(22) Filed: Dec. 9, 2010

(30) Foreign Application Priority Data
Jun. 25, 2010 (CN) 201010209988.4

(51) Int. Cl. B29C 45/73

(52) U.S. Cl. 264/328.16; 425/144

(57) ABSTRACT

An injection molding system includes a mold with a mold cavity, an injection device, and a temperature control device. The injection device is capable of injecting a molten material into the mold cavity. The temperature control device includes a heating system and a cooling system. The heating system utilizes hot fluid to increase a temperature of the mold to a predetermined upper temperature when the injection device starting to inject the material. The cooling system utilizes cool fluid to decrease the temperature of the mold to a predetermined low temperature when the material is being solidified in the mold cavity.

### BACKGROUND

1. Technical Field

The present disclosure relates to an injection molding system and method.

2. Description of Related Art

Injection molding is a well-known process which may be used for the fabrication of complexly shaped plastic or metal objects or parts. In the injection molding process, a molten thermoplastic or metal material is introduced into a mold and allowed to set or cure by cooling. Once the plastic or metal is set or cured, the mold is opened, and the molded object is released. The temperature of the injection mold is preferably controlled so that the mold is at the proper temperature when the molten material is injected into the mold and such that the object formed in the mold is set or cured at an optimal rate to both maintain the quality of the molded object while minimizing the setting or curing time to maximize production rates.

A typical injection molding system and method usually utilizes a temperature sensor to sense a temperature of the mold and a cooler to cool the mold. The mold is heated by the molten material injected thereto, then cooled by the cooler to solidify the molten material. However, the typical injection molding system and method cannot maintain the mold at an optimal temperature throughout the injection molding process.

Therefore, there is room for improvement within the art.

### BRIEF DESCRIPTION OF THE DRAWINGS

FIG. 1 a block diagram of an injection molding system according to an embodiment of the present disclosure.

FIG. 2 is a drawing that shows an arrangement of a heating system of the injection molding system in FIG. 1.

FIG. 3 is a drawing that shows an arrangement of a cooling system of the injection molding system in FIG. 1.

FIG. 4 is a flowchart of an embodiment of an injection molding method.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean at least one.

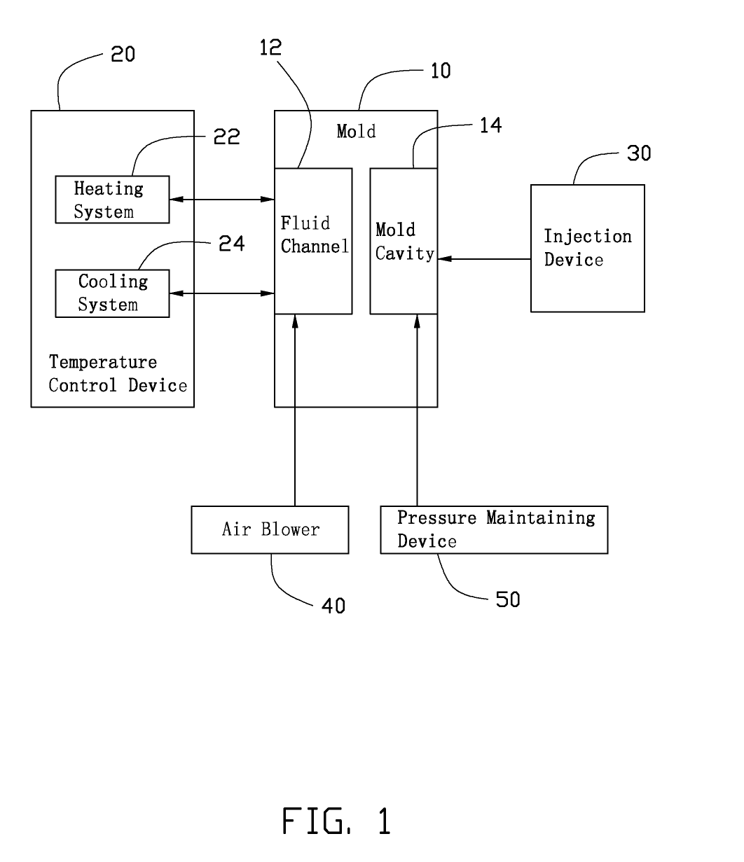

Referring to FIG. 1, an embodiment of an injection molding system includes a mold 10, a temperature controlling device 20, an injection device 30, and an air blower 40, and a pressure maintaining device 50.

The mold 10 includes a fluid channel 12 and a mold cavity 14. The injection device 30 can inject a molten material into the mold cavity 14. The mold cavity 14 determines the size and shape of the article molded by the mold 10. The mold 10 includes male and female mold parts. The mold cavity 14 is formed between the male and female mold parts.

The temperature control device 20 includes a heating system 22 and a cooling system 24. The heating system 22 can output hot fluid (e.g., hot water) to the fluid channel 12 of the mold 10 for heating up the mold 10. The cooling system 24 can output cold fluid (e.g., ice water) to the fluid channel 12 of the mold 10 for cooling the mold 10. Both the hot fluid and the cold fluid can be reclaimed after flowing through the fluid channel 12.

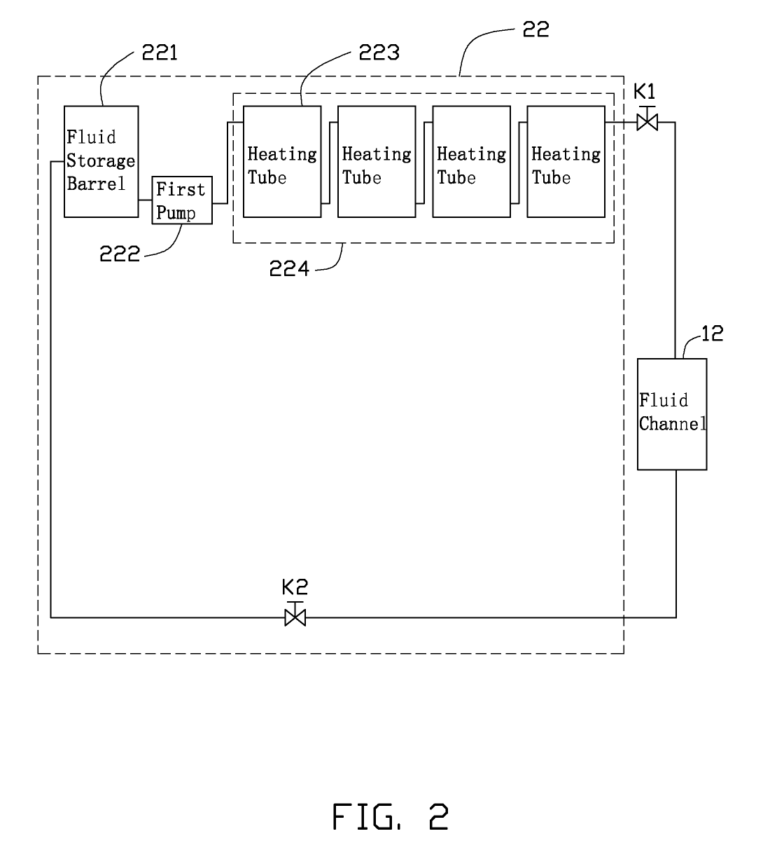

Referring to FIG. 2, the heating system 22 includes a fluid storage barrel 221, a first pump 222, a heating module 224, a first valve K1, and a second valve K2. The first pump 222 is connected to the fluid storage barrel 221 to pump fluid from the fluid storage barrel 221 to the heating module 224. The heating module 224 includes a plurality heating tubes 223 connected in series. In one embodiment there are four heating tubes 223. The heating tubes 223 can heat up the fluid flowing from the fluid storage barrel 221 to a predetermined upper temperature (e.g. 90° C.). The first valve K1 is connected between an output port of the heating module 224 and an input port of the fluid channel 12 of the mold 10. The second valve K2 is connected between an output port of the fluid channel 12 and the fluid storage barrel 221.

To heat up the mold 10, the first valve K1 and the second valve K2 are both open. The first valve K1 allows hot fluid heated by the heating tubes 223 to be pumped into the fluid channel 12 of the mold 10. The hot fluid then flows out from the fluid channel 12 and flows back to the fluid storage barrel 221.

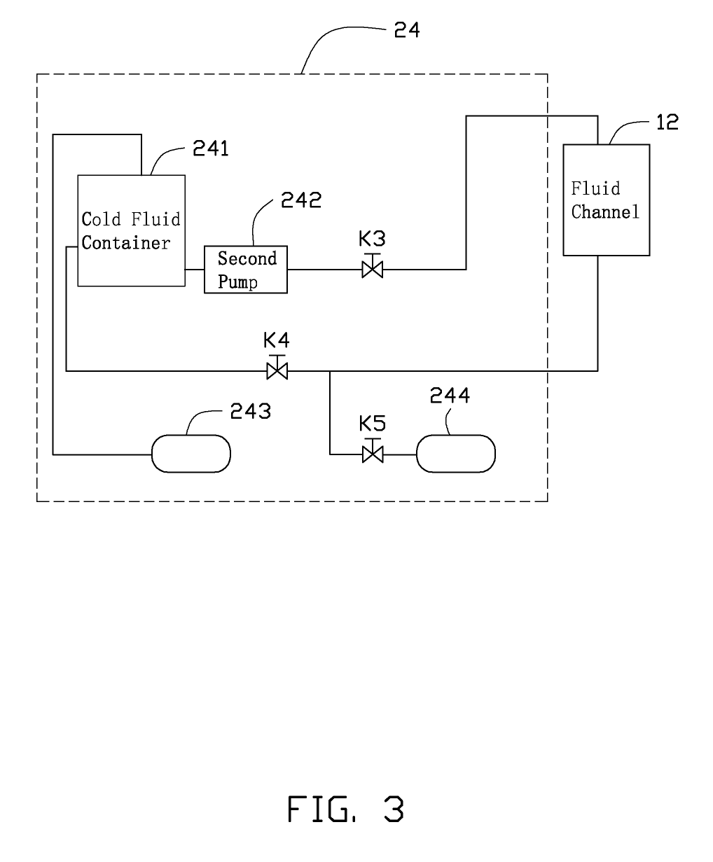

Referring to FIG. 3, the cooling system 24 includes a cold fluid container 241, a second pump 242, a cold fluid source 243, a third valve K3, a fourth valve K4, a fifth valve K5, and a recycling container 244. The second pump 242 is connected between the fluid container 241 and the fluid channel 12 for pumping cold fluid to the fluid channel 12. The cold fluid source 243 provides cold fluid to the cold fluid container 241. The third valve K3 is connected between the second pump 242 and the input port of the fluid channel 12 of the mold 10. The fourth valve K4 is connected between the output port of the fluid channel 12 and the cold fluid container 241. One port of the fifth valve K5 is connected to the output port of the fluid channel 12, and another port of the fifth valve K5 is connected to the recycling container 244. To cool the mold 10, the third valve K3 is opened to allow cold fluid to be pumped into the fluid channel 12 of the mold 10. One of the fourth valve K4 and the fifth valve K5 is opened to allow fluid to flow out from the fluid channel 12 into either the cold fluid container 241 or the recycling container 244.

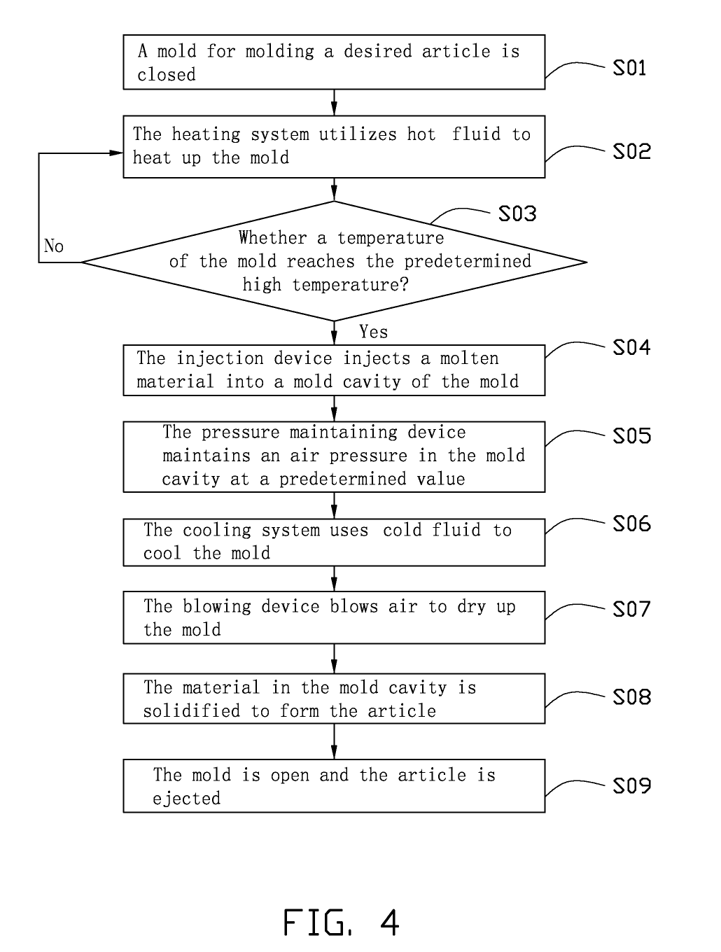

Referring to FIG. 4, an injection molding method based upon above injection molding system includes following blocks.

S01: the mold 10 is closed and the mold cavity 14 is defined in the mold 10.

S02: the heating system 22 causes hot fluid to flow through the fluid channel 12 to heat up the mold 10. In this block, the first valve K1 and the second valve K2 are open. The first pump 222 pumps fluid from the fluid storage barrel 221 to the heating tubes 223. The heating tubes 223 heat up the fluid and outputs the heated fluid to the fluid channel 12 to heat up the mold 10 to the predetermined upper temperature. The heated fluid then flows back to the fluid storage barrel 221.

S03: Whether the temperature of the mold 10 reaches the predetermined upper temperature is determined. If yes, go to block S04; if not, go back to block S02 to continue heating the mold 10.

S04: the injection device 30 injects a molten material into the mold cavity 14 of the mold 10.

S05: the pressure maintaining device 50 regulates air pressure in the mold cavity 14 to maintain pressure at a predetermined value to compensate for material shrinkage.

S06: the cooling system 24 causes cold fluid to flow through the fluid channel 12 to cool the mold 10. In this block, the third valve K3 is open to allow cold fluid to flow into the fluid channel 12 to the mold 10. The second pump 242 pumps the cold fluid from the cold fluid container 241 to the fluid channel 12 to cool down the mold 10 to a predetermined low temperature (e.g. 0° C.). One of the fourth valve K4 and the fifth valve K5 is open to let fluid flow into either the cold fluid container 241 or the recycling container 244.

S07: The air blower 40 blows air into the fluid channel 12 of the mold 10 to dry the channel 12.

S08: The material in the mold cavity 14 is solidified to form the article.

S09: the mold 10 is open and the article is ejected.

In one embodiment, the heating system 22 and the cooling system 24 of the temperature control device 20 work in turn to heat or cool the mold 10 at appropriate time during the injection molding process. The temperature of the mold 10 is increased to the predetermined high value just prior to or when the material starts to be injected into the mold cavity 14 of the mold 10. The temperature of the mold 10 is decreased to the predetermined low value during solidifying the material in the mold 10. This temperature control manner can improve the quality of the molded article.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

1. An injection molding system comprising:
a mold having a fluid channel and an mold cavity configured to receive molten materials; and
a temperature control device comprising a heating system and a cooling system, the heating system configured to insert hot fluid to the fluid channel to heat the mold, and the cooling system is configured to insert cold fluid to the fluid channel to cool the mold;
wherein the heating system comprises a fluid storage barrel and a plurality of heating tubes connected to the fluid storage barrel, the plurality of heating tubes are connected to each other in series and configured to heat fluid that is flowing from the fluid storage barrel to the fluid channel.

2. The injection molding system of claim 1, wherein the heating system comprises a fluid storage barrel and a heating module, and the heating module is configured to heat fluid flowing from the fluid storage barrel.

3. The injection molding system of claim 2, wherein the heating system further comprises a first valve and a second valve, the first valve is located between the heating module and an input port of the fluid channel, and the second valve is located between an output port of the fluid channel and the fluid storage barrel.

4. The injection molding system of claim 3, wherein the heating system further comprising a first pump, connected to the fluid storage barrel, that is configured to pump fluid out from the fluid storage barrel.

5. The injection molding system of claim 1, wherein the cooling system comprises a cold fluid container and a second pump that is configured to pump cold fluid out from the cool fluid container.

6. The injection molding system of claim 5, wherein the cooling system further comprises a third valve and a fourth valve, the third valve is located between the cool fluid container and the fluid channel, and the fourth valve is located between the fluid channel and the cool fluid container.

7. The injection molding system of claim 1, further comprising an air blower that is configured to blow air in the fluid channel.

8. The injection molding system of claim 1, further comprising a pressure maintaining device, connected to the mold, configured to maintain an air pressure in the mold cavity.

9. The injection molding system of claim 1, further comprising an injection device configured to inject molten materials into the mold cavity.

10. An injection molding method, comprising: pumping fluid from a fluid storage barrel to a mold;
heating the fluid by a plurality of heating tubes that are connected in series when the fluid is flowing to the mold;
introducing hot fluid flowing from the plurality of heating tubes to heat up the mold to a predetermined upper temperature;
injecting a molten material to the mold cavity;
using cold fluid to cool down the mold to a predetermined lower temperature.

11. The injection molding method of claim 10, further comprising maintaining air pressure in the mold cavity.

12. The injection molding method of claim 11, wherein the introducing hot fluid to heat up the mold comprises opening a first valve which allows hot fluid to flow into the mold.

13. The injection molding method of claim 12, wherein the introducing hot fluid to heat up the mold further comprises opening a second valve which allows hot fluid to flow out from the mold.

14. The injection molding method of claim 10, wherein the step of using cool fluid to cool down the mold comprises opening a third valve which allows cool fluid to flow into the mold.

15. The injection molding method of claim 14, wherein the step of using cool fluid to cool down the mold comprises opening a fourth valve which allows cool fluid to flow out from the mold.

16. The injection molding method of claim 10, further comprising molding a solidified article from the molten material and opening the mold.
